(19) United States
(12) Patent Application Publication
(10) Pub. No.: US 2025/0041737 A1
(43) Pub. Date: Feb. 6, 2025

(54) RECORDING MEDIUM AND INFORMATION PROCESSING DEVICE

(71) Applicant: SEGA CORPORATION, Tokyo (JP)

(72) Inventor: Takahiro Otomo, Tokyo (JP)

(73) Assignee: SEGA CORPORATION, Tokyo (JP)

(21) Appl. No.: 18/927,515

(22) Filed: Oct. 25, 2024

Related U.S. Application Data
(63) Continuation of application No. PCT/JP2023/009332, filed on Mar. 10, 2023.

(30) Foreign Application Priority Data
May 11, 2022 (JP) 2022-078002

(51) Int. Cl. A63F 13/795; A63F 13/2145; A63F 13/69; A63F 13/847

(52) U.S. Cl. CPC A63F 13/795; A63F 13/69; A63F 13/847; A63F 13/2145

(57) ABSTRACT

A non-transitory computer readable recording medium stores instructions for executing a multiplayer game, the instructions causing a computer to execute: setting a costume for two or more of a plurality of player characters, wherein the costume is selected by a player from among a plurality of costumes owned by the player; matching up the player characters whose costumes have been set; identifying, from among the matched up player characters, a player character whose set costume has a lower value than a predetermined value; and giving a special reward to the player in response to a play evaluation of the player associated with the identified player character satisfying a game condition.

### BACKGROUND

### Technical Field

The present invention relates to a recording medium storing instructions and an information processing device.

### Description of Related Art

Conventional video games include games in which the appearance of a player character can be personalized (given individual characteristics) by having the player character wear a costume (skin).

In regard to this, Patent Literature 1 discloses a technique that allows a player to select a costume for their player character.

### PATENT LITERATURE

Patent Literature 1: Japanese Patent No. 2009-233292 TECHNOLOGICAL PROBLEM TO BE SOLVED BY THE INVENTION

In such conventional gaming technology, a player who set their player character with a costume with a lower value than that of the costumes set for the surrounding player characters became passive when playing the game.

### SUMMARY

One or more embodiments of the present invention provide a recording medium storing instructions and an information processing device that modify functionality of a computer to give a predetermined reward to a player whose costume has a lower value than a predetermined value with a specific algorithm, whereby encourages the player to play a game more proactively.

The recording medium according to a first mode of the present invention is a non-transitory computer readable recording medium storing instructions for executing a multiplayer game, the instructions causing a computer to execute: setting a costume for two or more of a plurality of player characters, wherein the costume is selected by a player from among a plurality of costumes owned by the player; matching up the player characters whose costumes have been set; identifying, from among the matched up player characters, a player character whose set costume has a lower value than a predetermined value; and giving a special reward to the player in response to a play evaluation of the player associated with the identified player character satisfying a game condition.

In a second mode of the present invention, the costume lacks a parameter advantageous in the game.

In a third mode of the present invention, the game is a cooperative game in which the player characters constituting a team cooperate with each other, and the player characters constituting the team are matched up.

In a fourth mode of the present invention, the predetermined value is an average value of the set costumes of the remaining player characters constituting the team.

In a fifth mode of the present invention, the special reward is a special costume with a higher value than the set costumes of the identified player character.

In a sixth mode of the present invention, the special reward is a right to purchase a special costume with a higher value than the set costumes of the identified player character.

In a seventh mode of the present invention, the special reward is the right to purchase the special costume at a lower purchase price than usual.

In an eighth mode of the present invention, the special reward is given to the player in response to the player associated with the identified player character being a paying player during a specific period.

The information processing device according to a ninth mode of the present invention is an information processing device that executes a multiplayer game, the information processing device comprising: a central processing unit (CPU) that: sets a costume for two or more of a plurality of player characters, wherein the costume is selected by a player from among a plurality of costumes owned by the player, matches up the player characters whose costumes have been set, identifies, from among the matched up player characters, a player character whose set costume has a lower value than a predetermined value, and gives a special reward to the player in response to a play evaluation of the player associated with the identified player character satisfying a game condition.

With one or more embodiments of the present invention, it becomes possible to modify the functionality of the computer to give a predetermined reward to a player whose set costume has the lower value than the predetermined value with a specific algorithm, whereby encourages the player to play the game more proactively.

### BRIEF DESCRIPTION OF THE DRAWINGS

FIG. 1 is a block diagram showing an example of the overall configuration of a game system according to a first embodiment;

FIG. 2 is a diagram schematically showing an example of the hardware configuration of a server device;

FIG. 3 is a diagram showing an example of the hardware configuration of a smartphone, as the terminal device shown in FIG. 1;

FIG. 4 is a block diagram showing an example of the functional configuration of a server device;

FIG. 5 is a flowchart showing an example of the flow of processing performed by each functional units shown in FIG. 4 in the game system according to the first embodiment;

FIG. 6 is a diagram showing an example of an inquiry screen according to the first embodiment;

FIG. 7 is a diagram showing an example of a notification screen according to the first embodiment;

FIG. 8 is a flowchart showing an example of the flow of processing performed by each functional units in the game system according to a second embodiment; and

FIG. 9 is a diagram showing an example of a notification screen according to the second embodiment.

### DETAILED DESCRIPTION

A number of embodiments of the present invention will now be described with reference to the appended drawings. To facilitate understanding of the description, components and steps that are the same will be numbered the same as much as possible in the drawings, and redundant description will be omitted.

### First Embodiment

A first embodiment will be described now.

### Overall Configuration

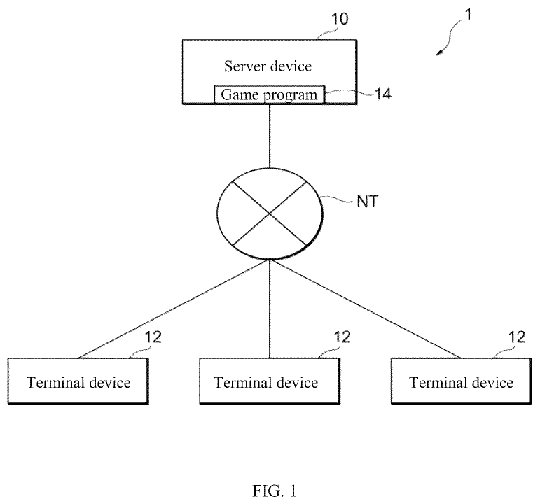

FIG. 1 is a block diagram showing an example of the overall configuration of a game system 1 according to the first embodiment.

As shown in FIG. 1, a game system 1 comprises a server device 10 and one or more terminal devices 12. The server device 10 and terminal devices 12 are connected so as to be able to communicate via a communication network NT such as an intranet, the Internet, or a telephone line.

The server device 10 is an information processing device that provides the execution results of the game obtained by executing instructions including a game program 14, or the instructions themselves, to the player of each terminal device 12 via the communication network NT. In the first embodiment, the server device 10 provides the instructions themselves to the players of the terminal devices 12.

Each terminal device 12 is an information processing device belonging to a player, and is an information processing device that provides a game to a player by executing the instructions received from the server device 10 after the instructions have been installed. Examples of these terminal devices 12 include video game machines, arcade game machines, mobile phones, smartphones, tablets, personal computers, and various other such devices.

### Hardware Configuration

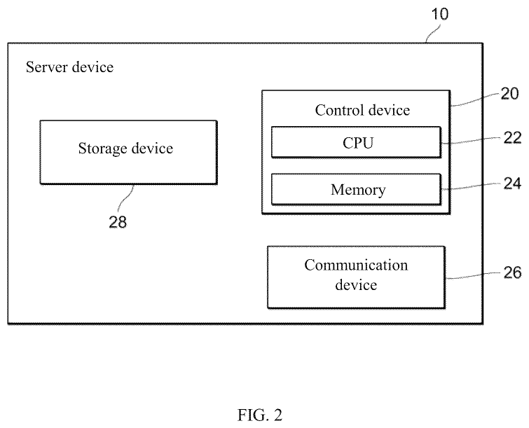

FIG. 2 is a diagram schematically showing an example of the hardware configuration of the server device 10.

As shown in FIG. 2, the server device 10 comprises a control device 20, a communication device 26, and a storage device 28. The control device 20 mainly comprises a CPU (central processing unit) 22 and a memory 24.

In the control device 20, the CPU 22 functions as various functional units by executing specific instructions stored in the memory 24, the storage device 28, or the like. These functional units will be described in detail below.

The communication device 26 is constituted by a communication interface or the like for communicating with an external device. The communication device 26 sends and receives various kinds of information to and from the terminal device 12, for example.

The storage device 28 is constituted by a hard disk or the like. The storage device 28 stores various kinds of instructions and various kinds of information necessary for executing processing in the control device 20, including the game program 14, as well as information about processing results.

The server device 10 can be realized by using an information processing device such as a dedicated or general-purpose server computer. Also, the server device 10 may be constituted by a single information processing device, or may be constituted by a plurality of information processing devices distributed on the communication network NT. Also, FIG. 2 shows only a part of the main hardware configuration of the server device 10, and the server device 10 can comprise other components that are ordinarily provided to a server. Also, the hardware configuration of the plurality of terminal devices 12 may have the same configuration as the server device 10, except for further comprising an operating device, a display device, and a sound output device, for example.

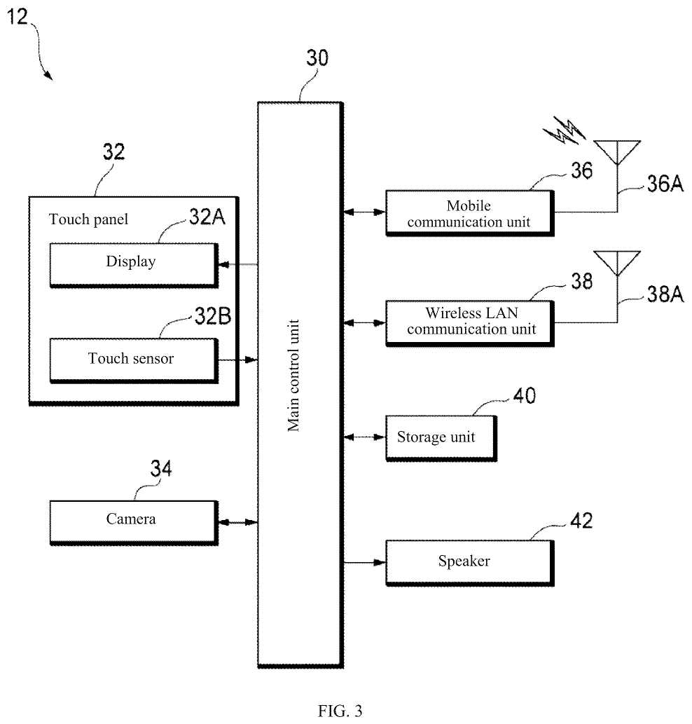

FIG. 3 is a diagram showing an example of the hardware configuration of a smartphone serving as the terminal device 12 shown in FIG. 1.

As shown in FIG. 3, the terminal device 12 comprises a main control unit 30, a touch panel (touch screen) 32, a camera 34, a mobile communication unit (or mobile communication interface) 36, a wireless LAN communication unit (or wireless LAN communication interface) 38, a storage unit (or storage) 40, and a speaker 42.

The main control unit 30 includes a CPU, a memory, and so forth. This main control unit 30 is connected to the touch panel 32 (used as a display input device), the camera 34, the mobile communication unit 36, the wireless LAN communication unit 38, the storage unit 40, and the speaker 42. The main control unit 30 has the function of controlling these connected devices.

The touch panel 32 has both a display function and an input function, and is constituted by a display 32A that handles the display function, and a touch sensor 32B that handles the input function. In the first embodiment, the display 32A can display game images including button images, a cross key image, a joystick image, and other such operation input images. The touch sensor 32B can sense the input position of the player with respect to a game image.

The camera 34 has the function of capturing still and/or moving images and storing these images in the storage unit 40.

The mobile communication unit 36 is connected to a mobile communication network via an antenna 36A, and has the function of communicating with other communication devices that are connected to this mobile communication network.

The wireless LAN communication unit 38 is connected to the communication network NT via an antenna 38A, and has the function of communicating with other devices, such as the server device 10, that are connected to the communication network NT.

The storage unit 40 stores various kinds of instructions and data, such as the game program 14, and play data indicating player information or the progress of the game in the instructions. This play data may be stored in the server device 10.

The speaker 42 has the function of outputting game sounds and so forth.

### Game Overview

The game according to the first embodiment is not particularly limited as long as it is a multiplayer game in which a plurality of player characters are matched up with one another. With this game, a player character associated with the player performs actions such as moving or attacking in the game space when the player operates the touch panel 32 (issues an instruction), for example. An example of this game is a cooperative game in which a plurality of (two or more) player characters constituting a team cooperate with each other. In this cooperative game, four player characters constituting a team cooperate to fight against an enemy character, for example. This cooperative game ends, for example, when all of the player characters on the team are immobilized, or when a boss character that appears in the final stage is immobilized. Also, a costume selected by each player is set for these player characters. This costume is granted to the player by purchasing it with currency items (game currency), or through a lottery game, for example. In the first embodiment, costumes are associated with a value (rarity) that depends on the purchase price and the probability of winning a lottery. A currency item is an item that the player can acquire through a purchasing procedure (payment with cash or electronic money, a credit card payment, etc.).

Also, in the first embodiment, the costume does not have various parameters (such as defense power or stamina) that are advantageous in the game (cooperative game), and is an object used only to personalize the appearance of a player character.

### Functional Units

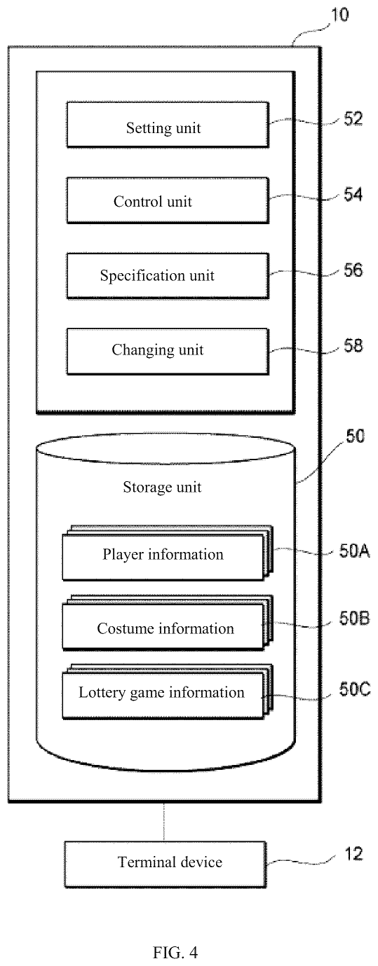

FIG. 4 is a block diagram showing an example of the functional configuration of the server device 10.

As shown in FIG. 4, the server device 10 comprises, as functional components, a storage unit (or storage) 50, a setting unit 52, a control unit 54, a specification unit 56, and a changing unit 58. The storage unit 50 is realized in the form of one or more storage devices 28. Functional units other than the storage unit 50 are realized when the control device 20 executes the instructions stored in the storage device 28 or the like.

The storage unit 50 is a functional unit for storing player information 50A, costume information 50B, lottery game information 50C, and so forth.

Player information 50A is stored for each player in association with the player ID of that player. This player information 50A includes, for example, the player's name, age, possessed content information, and so forth.

Possessed content information includes possessed item information, possessed costume information, and so forth. Possessed item information includes the type and quantity of the items possessed by the player. Examples of these items include currency items, costume change items, and so forth. Possessed costume information includes the costume ID of costumes possessed by the player.

Costume information 50B is stored for each costume in association with the costume ID of that costume. Costume information 50B includes, for example, the name and image (e.g., a 3D model) of the costume, its rarity, and the purchase price. New costumes are added to this costume information 50B through a game update (a version upgrade or update) by the game operator, for example.

Rarity may be represented by any number from 1 to 6, for example. This number indicates the value of the costume. This number may be indicated by a number of stars, for example. For example, the higher the rarity of a costume, the higher its purchase price, or the lower the probability of winning the costume in a lottery game. Also, for example, the higher the rarity of a costume, the more luxurious its appearance.

The purchase price includes the number of currency items, for example. This purchase price is associated with costumes that can be purchased in the in-game shop. For example, costumes with a low rarity have a low purchase price (low number of currency items).

Lottery game information 50C is stored for each lottery game in association with the lottery game ID of that lottery game. The lottery game information 50C includes the lottery game name and cost, lottery target information, and so forth.

Cost includes the number of currency items required to execute one lottery.

Lottery target information includes the costume IDs of the costumes constituting the lottery target costume group that is the lottery target of a lottery game, and the appearance frequency (weighting) associated with that costume ID. Appearance frequency may be represented by any number from 1 to 10, for example. The appearance frequency is set to a low numerical value for a costume with a high rarity, and to a high numerical value for a costume with a low rarity. The appearance frequency may be set to different numerical values among costumes of the same rarity (such as a rarity of 6). Here, the probability of drawing one costume is a value obtained by dividing the appearance frequency set for that one costume by the total value of the appearance frequencies set for each of the costumes that constitute the lottery target costume group. More specifically, if the appearance frequency set for one costume is 2 and the total value of the appearance frequencies set for each of the costumes that constitute the lottery target costume group is 400, the probability of drawing that one costume is 2/400 (0.5%).

The setting unit 52 is a functional unit for setting the costume for a player character. In the first embodiment, the setting unit 52 sets for the player character a costume selected by the player before the start of the game from among the costumes owned by the player. This set costume becomes the player character's appearance (how the character looks) during the game, and allows the player character to be differentiated from the appearances of other player characters.

The control unit 54 is a functional unit for controlling the entire game. In the first embodiment, the control unit 54 matches up a plurality of player characters whose costumes have been set by the setting unit 52, and executes a game. This game may be a cooperative game as described above. For example, the control unit 54 matches up a plurality of (such as four) player characters that constitute a team. The plurality of player characters constituting this team cooperate as allies (friends) with the objective of defeating (killing) a boss character that appears in the final stage.

Also, the control unit 54 allows a player character identified by the specification unit 56 from among the player characters matched up in the game (hereinafter referred to as the “specific player character”) to acquire a special reward. In the first embodiment, the control unit 54 allows a player associated with a specific player character (hereinafter referred to as a “specific player”) to receive a special reward as a reward for a predetermined change. For example, when a specific player plays the game proactively, the control unit 54 allows that specific player to acquire a special reward in the game. More specifically, when the play evaluation of a specific player in the game satisfies a specific condition (or game condition), the control unit 54 allows that specific player to acquire a special reward. This special reward is one that can only be obtained by a specific player, for example.

Examples of this special reward include a special costume with a higher value (rarity) than the costume set for a specific player character (hereinafter referred to as a “specific costume”), the right to purchase a special costume, and the right to purchase a special costume at a lower purchase price than usual (such as at a 50% discount off the purchase price).

The play evaluation is, for example, a numerical value indicating whether or not the player is playing the game proactively. Specific examples of play evaluations and specific conditions will be described below.

### (1) Evaluation by Numerical Value

The play evaluation may include, for example, numerical values from 0 to 99. For instance, the control unit 54 calculates (i.e., increases or decreases) the numerical value of the play evaluation on the basis of a specific action performed by a specific player character associated with a specific player. More specifically, the control unit 54 increases the numerical value of the play evaluation according to the number of times a specific player character has attacked an enemy character, the number of hits (such as with bullets) the specific player character has inflicted in an attack, the amount of damage inflicted, the number of enemy characters immobilized, the number of rescues of a player character on the same team (hereinafter referred to as an “ally character”) by the specific player character, etc. On the other hand, the control unit 54 decreases the numerical value of the play evaluation if, within a specific length of time, a specific player character does not attack an enemy character even once, or if the specific player character stays within a specified range (i.e., does not move a specific distance), or if the specific player character is rescued by an ally character, etc.

At the point when the game ends, for example, if the numerical value of the play evaluation for a specific player is at or above a specific value (such as 80), the control unit 54 allows the specific player to acquire a special costume with a higher rarity than the specific costume set for the specific player character.

### (2) Evaluation by Mission Accomplishment

The play evaluation may include, for example, the number of missions completed (numerical value). For instance, the control unit 54 increases the numerical value of the play evaluation by one every time a specific player character associated with a specific player completes a predetermined mission. Examples of such missions include hitting enemy characters with an attack at least a specific number of times, inflicting at least a specific amount of total damage on enemy characters, immobilizing at least a specific number of enemy characters, rescuing ally characters at least a specific number of times, and so forth.

At the point when the game ends, for example, if the numerical value of the play evaluation of a specific player is at or above a specific value (such as 3), the control unit 54 allows the specific player to acquire the right to purchase a special costume with a higher rarity than the specific costume set for the identified player character.

Also, the control unit 54 allows a specific player associated with a specific player character to acquire a special reward when the specific player is a paying player during a specific period. For example, when a specific player purchases an event pass with cash, currency items, or the like, the control unit 54 allows that specific player to acquire a special reward as a paying player. A validity period may be set for this event pass, for example. This validity period may be from the time the event pass is purchased or consumed until the end of the event period, or may be until a specific period of time has elapsed (such as one month).

The specification unit 56 is a functional unit for specifying or identifying a player character. In the first embodiment, the specification unit 56 identifies as a specific player character, from among the player characters matched up in a game (such as a cooperative game), a player character whose costume set by the setting unit 52 has a lower value than a predetermined value. For example, the specification unit 56 may identify, from among the player characters matched up in a team, some of the player characters whose costumes have lower values than a predetermined value. More specifically, the specification unit 56 may identify as specific player characters, from among the player characters matched up in a team, the player character who has been set with a costume with the lowest rarity and the player character who has been set with a costume with the second lowest rarity.

Or the specification unit 56 may identify as a specific player character, from among the player characters matched up in a game (such as a cooperative game), a player character whose costume value set by the setting unit 52 is lower than the average value of the costumes set for the player characters constituting a team. For example, if the average rarity of costumes set for player characters constituting a team is 5, the specification unit 56 may identify as specific player characters the player characters on that team that have set costumes with a rarity of less than 5.

The changing unit 58 is a functional unit for changing a costume that has been set. In the first embodiment, when the determination by the specification unit 56 is affirmative, the changing unit 58 changes the specific costume to a special costume with a high value in the game (such as a cooperative game). In other words, the changing unit 58 lends a special costume to a specific player during the game.

For example, the changing unit 58 may change a specific costume to a special costume with a rarity of at least 5. For example, the changing unit 58 may change a specific costume to a special costume from the beginning of a game (such as a cooperative game) until the end.

The changing unit 58 may also ask a specific player whether or not they want to change a specific costume to a special costume, and if the specific player agrees to the change, may change the specific costume to the special costume. Or, the changing unit 58 may forcibly change a specific costume to a special costume without asking first.

Also, the changing unit 58 may, for example, present a plurality of special costumes as options to a specific player, and change the costume to one costume (special costume) selected by the specific player.

Also, when the value of a specific costume is lower than the average value of the costumes set for the player characters constituting a team, the changing unit 58 may change that specific costume to a special costume with a value at or above the average value.

More specifically, the changing unit 58 may change a specific costume set for a specific player character to a special costume with a rarity of at least 5 if the average rarity of the costumes set for the player characters constituting the team is 4.5.

Also, the changing unit 58 may change a specific costume to a special costume by consuming a specific item possessed by a specific player associated with a specific player character. Examples of these specific items include currency items, costume change items, and so forth.

### Flow of Processing

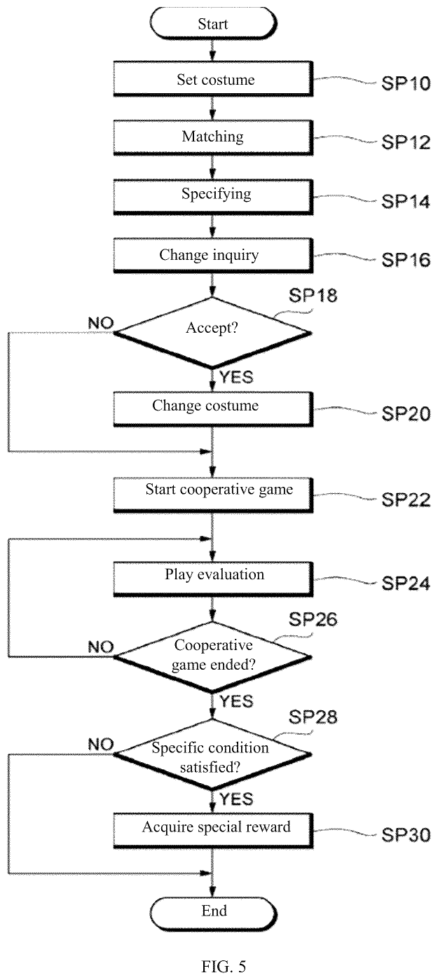

FIG. 5 is a flowchart showing an example of the flow of processing performed by each functional unit shown in FIG. 4 in the game system according to the first embodiment. Also, the processing of the following steps is commenced, for example, at the point when one player has entered into a cooperative game. The order and details of the following steps can be changed as needed.

### Step SP10

The setting unit 52 refers to possessed costume information in the player information 50A and causes the touch panel 32 to display a list screen of costumes possessed by the one player. The setting unit 52 then accepts a costume selection on the list screen from the one player, and sets the selected costume to the player character associated with the one player. Then, the processing moves to the processing of step SP12.

### (Step SP12)

The control unit 54 matches up a plurality of player characters whose costumes have been set in step SP10. For example, the control unit 54 matches up four player characters as a single team. Examples of the player characters that are matched up here include player characters associated with players who entered the cooperative game at the same time as the one player. Then, the processing moves to the processing of step SP14.

### (Step SP14)

The specification unit 56 calculates the average value of the rarity of the costumes set for the player characters on the team matched up in step SP12. Next, the specification unit 56 identifies as a specific player character a player character on the team that is set with a costume having a rarity lower than the average value. Then, the processing moves to the processing of step SP16.

### (Step SP16)

The changing unit 58 asks the specific player associated with the specific player character identified in step SP14 whether or not they want to change the set costume (specific costume) to a special costume. For example, the changing unit 58 causes the touch panel 32 of the terminal device 12 owned by the specific player to display an inquiry screen for asking the specific player about this.

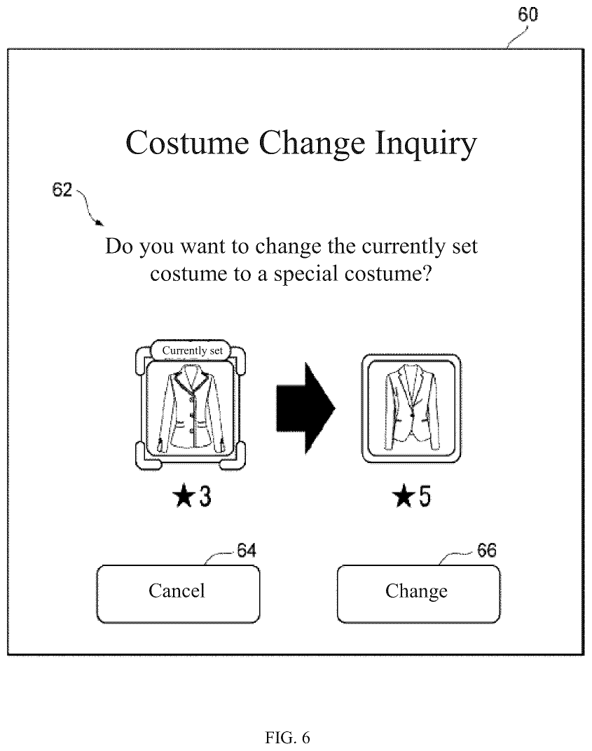

FIG. 6 is a diagram showing an example of an inquiry screen 60 according to the first embodiment.

As shown in FIG. 6, the inquiry screen 60 is provided with an inquiry area 62, a cancel button 64, and a change button 66. Costumes set by a specific player (specific costumes) and special costumes are displayed in the inquiry area 62. This special costume is, for example, a predetermined costume, and is a costume that is set to a rarity higher than the average value of the costumes set for the player characters on the team. The cancel button 64 is used to issue an instruction (refusal) not to change the currently set costume to a special costume. The change button 66 is used to issue an instruction (approval) to change the currently set costume to a special costume.

Going back to FIG. 5, the processing moves to the processing of step SP18.

### (Step SP18)

The changing unit 58 determines whether or not the change button 66 has been pressed on the inquiry screen 60. Then, if this determination is affirmative, the processing moves to the processing of step SP20. On the other hand, if the determination is negative, that is, if the cancel button 64 has been pressed, the processing moves to the processing of step SP22.

### (Step SP20)

The changing unit 58 changes the costume (specific costume) set for the specific player character identified in step SP14 to a special costume. Then, the processing moves to the processing of step SP22.

### (Step SP22)

The control unit 54 commences a cooperative game in which a plurality of player characters constituting the team matched up in step SP14 cooperate with each other. Then, the processing moves to the processing of step SP24.

### (Step SP24)

The control unit 54 evaluates the play of a specific player in a cooperative game. For example, the control unit 54 calculates a play evaluation as a numerical value from 0 to 99. Then, the processing moves to the processing of step SP26.

### (Step SP26)

The control unit 54 determines whether or not the cooperative game has ended. For example, the control unit 54 makes an affirmative determination when all the player characters on a team are immobilized or when a boss character is immobilized. Then, if this determination is affirmative, the processing moves to the processing of step SP28. On the other hand, if the determination is negative, the processing moves to the processing of step SP24.

### (Step SP28)

The control unit 54 determines whether or not the play evaluation of a specific player satisfies a specific condition (or game condition) when a specific player changes the costume set for that specific player character to a special costume. An example of this specific condition is that the numerical value of the play evaluation is at least 80. Then, if this determination is affirmative, the processing moves to the processing of step SP30. On the other hand, if the determination is negative, the processing ends the processing series shown in FIG. 5.

### (Step SP30)

The control unit 54 allows a specific player to acquire a special reward. For example, the control unit 54 causes the touch panel 32 of the terminal device 12 owned by the specific player to display a notification screen notifying the specific player that they have acquired a special reward.

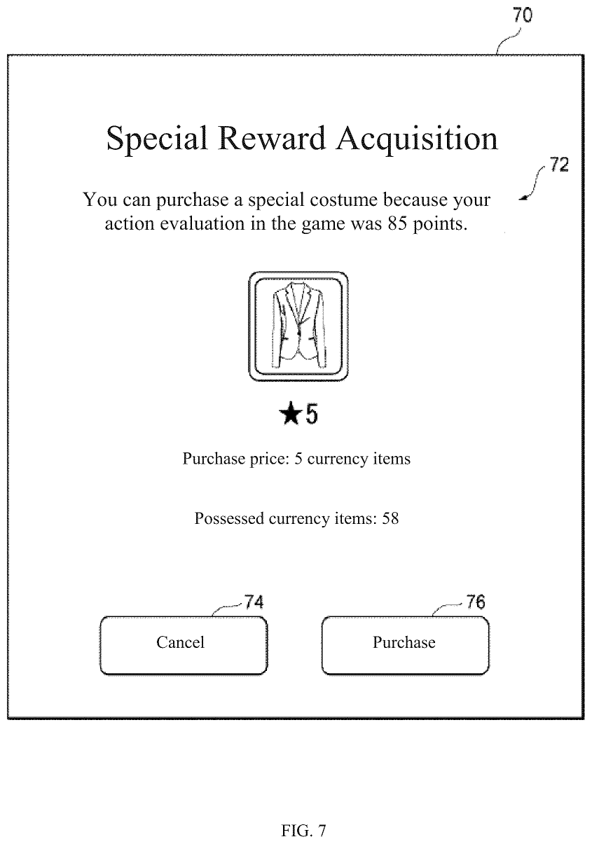

FIG. 7 is a diagram showing an example of the notification screen 70 according to the first embodiment.

As shown in FIG. 7, the notification screen 70 is provided with a special reward notification area 72, a cancel button 74, and a purchase button 76. Information such as the fact that a player has acquired the right to purchase a special costume (special reward) because the play evaluation satisfies a specific condition is displayed in the special reward notification area 72. For example, the special reward is the right to purchase the special costume that was changed in step SP20. The cancel button 74 is used to issue an instruction not to purchase a special costume. The purchase button 76 is used to issue an instruction to purchase a special costume.

Then, the processing of the processing series shown in FIG. 5 ends.

### Technological Effect

In the first embodiment described above, a recording medium storing instructions executing a multiplayer game with a plurality of player characters causes a computer to function as a setting unit 52 for setting, for a player character, a costume selected by a player from among the costumes owned by the player, a control unit 54 for matching up a plurality of player characters whose costumes have been set and executing a game, a specification unit 56 for identifying, from among the player characters matched up in the game, a player character whose set costume has a lower value than a predetermined value, and a changing unit 58 for changing the set costume of the identified player character in the game to a special costume having a higher value than the lower value of the set costume.

With this configuration, even if the player sets a costume with a lower value than those of the surrounding players, that costume can be changed to a special costume. This encourages a player whose set costume having a lower value than a predetermined value to play more proactively.

Also, in the first embodiment, the costume lacks any parameters that are advantageous in the game.

With this configuration, even if a costume having a lower value than a predetermined value is changed to a special costume, parameters that are advantageous in the game will not be changed, which ensures fairness to other players.

Also, in the first embodiment, the game is a cooperative game in which a plurality of player characters constituting a team cooperate with each other, and the control unit 54 matches up the plurality of player characters that constitute the team.

With this configuration, even if a player sets a costume with a lower value than those of the surrounding players in a cooperative game, that costume can be changed to a special costume. This encourages a player on the team who has set a costume having a lower value than a predetermined value to play more proactively.

Also, in the first embodiment, the specification unit 56 identifies, from among the player characters matched up in the cooperative game, a player character whose set costume value is lower than the average value of the costumes set for the player characters that constitute the team.

With this configuration, even if the player sets a costume with a lower value than the average value, that costume can be changed to a special costume. This encourages a player on the team whose set costume having a lower value than a predetermined value to play more proactively.

Furthermore, in the first embodiment, the changing unit 58 changes the costume to a special costume by consuming a specific item possessed by the player associated with a identified player character.

With this configuration, since the player can change to a special costume by consuming a specific item, fairness can be ensured in regard to other players whose costumes were not changed.

Also, with the first embodiment, when the play evaluation of the player associated with a identified player character in the game satisfies a specific condition, the control unit 54 allows that player to acquire a special reward.

With this configuration, if the play evaluation of a specific player satisfies a specific condition, the player is allowed to acquire a special reward, which encourages a player whose set costume having a lower value than a predetermined value to play more proactively.

Also, in the first embodiment, the special reward is a special costume.

With this configuration, since a player is allowed to acquire the changed special costume, this encourages a player whose set costume having a lower value than a predetermined value to play more proactively.

Also, in the first embodiment, the special reward is the right to purchase a special costume.

With this configuration, since the changed special costume can be purchased, this encourages a player whose set costume having a lower value than a predetermined value to play more proactively.

In the first embodiment, the special reward is the right to purchase a special costume at a lower purchase price than usual.

With this configuration, since the changed special costume can be purchased at a lower purchase price than usual, this encourages a player whose set costume having a lower value than a predetermined value to play more proactively.

Also, in the first embodiment, the control unit 54 allows the player associated with a identified player character to acquire a special reward if that player is a paying player during a specific period.

With this configuration, it is possible to ensure fairness to players whose costumes are not changed, and this encourages a player whose set costume having a lower value than a predetermined value to play more proactively.

### Second Embodiment

A second embodiment will now be described.

The second embodiment differs from the first embodiment in that, among other points, the control unit 54 allows a specific player to acquire a special reward even when the costume has not been changed by the changing unit 58. Aspects of the configuration and functions of the game system according to the second embodiment that are the same as those of the game system according to the first embodiment are omitted from the description below.

In the second embodiment, when the play evaluation of a specific player identified by the specification unit 56 in a game satisfies a specific condition, the control unit 54 allows the specific player to acquire a special reward. In other words, when a player (specific player) who has set a costume with a lower value than those of the surrounding players plays the game proactively, the control unit 54 allows that player (specific player) to acquire a special reward.

### Flow of Processing

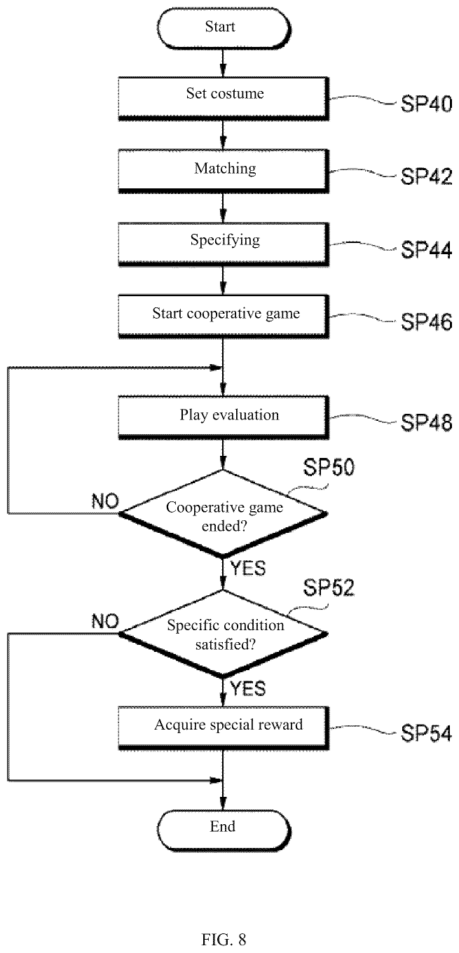

FIG. 8 is a flowchart showing an example of the flow of processing performed by each functional unit in the game system according to the second embodiment. Also, the processing of the following steps is commenced, for example, at the point when one player has entered into a cooperative game. The order and details of the following steps can be changed as needed.

### (Steps SP40 to SP44)

The processing of steps SP40 to SP44 is the same as the processing of steps SP10 to SP14 described above, and therefore will not be described again. Then, the processing moves to the processing of step SP46.

### (Step SP46)

The control unit 54 commences a cooperative game in which a plurality of player characters that were matched up to constitute a team in step SP42 cooperate with each other. Then, the processing moves to the processing of step SP48.

### (Step SP48)

The control unit 54 evaluates the play of a specific player in a cooperative game. For example, the control unit 54 increases the numerical value of the play evaluation by one each time the player character associated with the player completes a predetermined mission. Then, the processing moves to the processing of step SP50.

### (Step SP50)

The control unit 54 determines whether or not the cooperative game has ended. Then, if this determination is affirmative, the processing moves to the processing of step SP52. On the other hand, if the determination is negative, the processing moves to the processing of step SP48.

### (Step SP52)

The control unit 54 determines whether or not the play evaluation of a specific player satisfies a specific condition. An example of this specific condition is that the numerical value of the play evaluation (such as the number of completed missions) is at least 3. Then, if this determination is affirmative, the processing moves to the processing of step SP54. On the other hand, if the determination is negative, the processing of the processing series shown in FIG. 8 ends.

### (Step SP54)

The control unit 54 allows a specific player to acquire a special reward. For example, the control unit 54 causes the touch panel 32 of the terminal device 12 owned by the specific player to display a notification screen notifying the specific player that they have acquired a special reward.

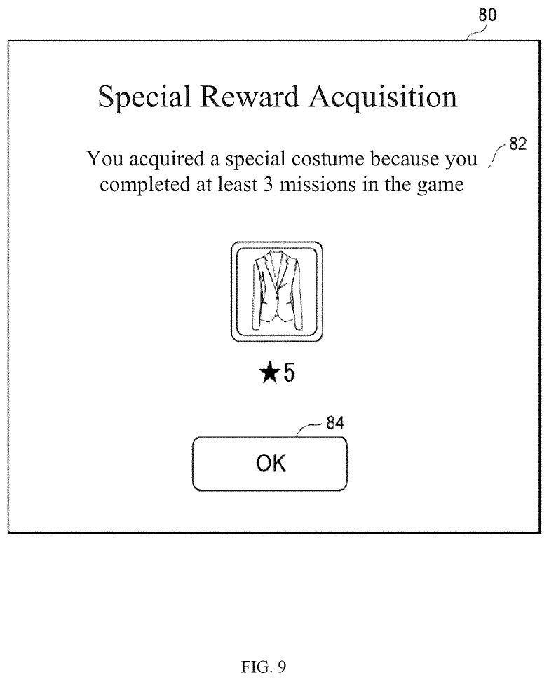

FIG. 9 is a diagram showing an example of the notification screen 80 according to the second embodiment.

As shown in FIG. 9, the notification screen 80 is provided with a special reward notification area 82 and an OK button 84. Information such as the fact that a special costume (special reward) has been acquired because the play evaluation satisfied a specific condition is displayed in the special reward notification area 82. The OK button 84 is used to acquire a special costume and to issue an instruction to end the cooperative game.

Then, the processing of the processing series shown in FIG. 8 ends.

### Technological Effect

In the second embodiment described above, a recording medium storing instructions executing a multiplayer game with a plurality of player characters causes a computer to function as a setting unit 52 for setting, for a player character, a costume selected by a player from among the costumes owned by the player, a control unit 54 for matching up a plurality of player characters whose costumes have been set, a specification unit 56 for identifying, from among the player characters matched up in the game, a player character whose set costume has a lower value than a predetermined value, and a changing unit 58 for changing the set costume of the identified player character to a special costume having a higher value than the value of the set costume, wherein the control unit 54 allows a player associated with the identified player character to acquire a special reward when the play evaluation of that player satisfies a specific condition.

With this configuration, even if a player has set a costume with a lower value than those of the surrounding players, that player can still acquire a special reward if they play the game proactively. This encourages a player whose set costume having a lower value than a predetermined value to play more proactively.

Also, in the second embodiment, the costume lacks any parameters that are advantageous in the game.

With this configuration, since the costume does not have any parameters that are advantageous in the game, a player whose set costume having a lower value than a predetermined value can play more proactively regardless of the parameters.

Also, in the second embodiment, the game is a cooperative game in which a plurality of player characters constituting a team cooperate with each other, and the control unit 54 matches up the plurality of player characters that constitute the team.

With this configuration, even if a player in a cooperative game sets a costume with a lower value than those of the surrounding players, the player can still acquire a special reward if they play the game more proactively. This encourages a player on the team whose set costume having a lower value than a predetermined value to play more proactively.

Also, in the second embodiment, the specification unit 56 identifies, from among the player characters matched up in the cooperative game, a player character whose set costume value is lower than the average value of the costumes set for the player characters that constitute the team.

With this configuration, even if the player sets a costume with a lower value than the average value, that player can still acquire a special reward if they play the game more proactively. This encourages a player on the team whose set costume having a lower value than a predetermined value to play more proactively.

Also, in the second embodiment, the special reward is a special costume with a higher value than the costume set for the identified player character.

With this configuration, since a player is allowed to acquire a special costume having a higher value than the value of the set costume, this encourages a player whose set costume having a lower value than a predetermined value to play more proactively.

Also, in the second embodiment, the special reward is the right to purchase a special costume with a higher value than the costume set for the identified player character.

With this configuration, since a player is allowed to purchase a special costume having a higher value than the value of the set costume, this encourages a player whose set costume having a lower value than a predetermined value to play more proactively.

Also, in the second embodiment, the special reward is the right to purchase a special costume at a lower purchase price than usual.

With this configuration, since a special costume having a higher value than the value of the set costume can be purchased at a lower purchase price than normal, this encourages a player whose set costume having a lower value than a predetermined value to play more proactively.

Also, in the second embodiment, the control unit 54 allows the player associated with a identified player character to acquire a special reward if that player is a paying player during a specific period.

With this configuration, it is possible to ensure fairness to players who own costumes having a higher value than the value of the set costume, while also encouraging players whose set costumes having a lower value than a predetermined value to play more proactively.

### Modifications

The present invention is not limited to or by the above specific examples. That is, suitable design changes made to the above specific examples by a person skilled in the art are also encompassed by the scope of the present invention as long as they still have the features of the present invention. Also, the elements of the embodiments described above and the modified examples (discussed below) can be combined to an extent that this is technically possible, and these combinations are also encompassed by the scope of the present invention as long as they still have the features of the present invention.

For example, in the first and second embodiments, an example was given in which the game was a cooperative game in which a plurality of player characters constituting a team cooperated with each other, but the game may instead be a competitive game in which player characters compete against one another (a battle royale game). Also, the cooperative game may be a battle game in which teams compete against one another (a battle royale game).

Also, in the first and second embodiments, an example was given in which the costumes did not have various parameters (such as defense power, stamina, etc.) that were advantageous in the game, but the costumes may instead have these parameters. For example, a costume with a high rarity may have parameters that are more advantageous in the game than a costume with a low rarity.

Also, in the first and second embodiments, an example was given in which the special reward was a special costume or the right to purchase a special costume, but it may instead be various items such as currency items or costume change items, content that can be used in the game, or the like.

Also, in the first and second embodiments, an example was given in which the setting unit 52 set a costume for a player character, but an emote (such as a dance) may instead be set for a player character. In this case, for example, the changing unit 58 may change a specific emote set for a specific player character to a special emote with a higher value. This emote may or may not include various parameters that are advantageous in the game.

Also, in the first and second embodiments, an example was given in which the control unit 54 allowed a specific player to acquire a special reward when the play evaluation of that specific player satisfied a specific condition, but the control unit 54 may instead allow another player associated with another player character on the team to acquire the special reward. For example, the control unit 54 may allow a special reward to be acquired when the action evaluation of another player satisfies a specific condition.

Also, when the play evaluation of a specific player satisfies a specific condition, the control unit 54 may conduct a lottery with a specific probability (such as 50%) to decide whether or not to allow the specific player to acquire a special reward.

Also, in the first embodiment, an example was given in which the changing unit 58 changed a specific costume to a special costume with a high rarity, but whether or not to change to a special costume may be determined by lottery. For example, the changing unit 58 may conduct a lottery with a specific probability, and if the player wins that lottery, the specific costume is changed to a special costume. For example, the changing unit 58 may conduct a lottery with a specific probability (such as 50%), and if the player wins that lottery, the specific costume is changed to the special costume.

Also, the changing unit 58 may change the costumes of players other than the specific player identified by the specification unit 56 to special costumes. For example, the changing unit 58 may determine the player character (player) whose set costume is to be changed to a special costume by lottery or based on how high (or low) the level of past play evaluation is.

Also, in the first embodiment, an example was given in which the changing unit 58 changed the specific costume to a special costume with a high rarity, but the special costume to be changed may be determined by lottery. For example, the changing unit 58 may change a specific costume to a special costume selected by lottery at a specific probability. For example, when the rarity of a specific costume is lower than the average value of the rarity of costumes set for player characters on a team, the changing unit 58 may select by lottery a special costume from among the costumes with higher rarities than the average value, and change the specific costume to the selected special costume. This specific probability may be set, for example, so that the higher the rarity of the special costume, the lower the probability.

Also, in the first embodiment, an example was given in which the changing unit 58 lent a special costume to a specific player during the game, but the special costume may be selected from among the costumes owned by the specific player. For example, when the rarity of a specific costume is lower than the average value on a team, and if a specific player owns a costume with a higher rarity than the average value, the changing unit 58 may change the specific costume to that costume having a higher rarity (special costume).

Also, in the first embodiment, an example was given in which the changing unit 58 changed the specific costume to a special costume from the beginning of the game until the end, but the changed special costume may also be changed back to a specific costume during the game. For example, the changing unit 58 may change the special costume back to the specific costume when a certain condition is satisfied during the game. Examples of this certain condition could include that an action evaluation value of a specific player remains below a specific number (such as 50) for a certain period of time, that a stamina value falls below a specific number, or that a specific player character is rescued by another player character.

Also, the changing unit 58 may change the specific costume to a special costume during the game. For example, the changing unit 58 may change the specific costume to a special costume when a certain condition is met during the game. Examples of this certain condition could include that an action evaluation value of specific player reaches a specific number (such as 80) or more, that the number of missions completed reaches a specific number (such as 3), that the number of times an enemy character has been hit with an attack reaches a specific value, that the total amount of damage inflicted on an enemy character reaches a specific amount, that the number of enemy characters immobilized reaches a specific value, and that the number of times an ally character has been rescued reaches a specific value.

### REFERENCE SIGNS LIST

10 . . . server device (computer) 12 . . . terminal device 50 . . . storage unit 52 . . . setting unit 54 . . . control unit 56 . . . specification unit

What is claimed is:

1. A non-transitory computer readable recording medium storing instructions for executing a multiplayer game, the instructions causing a computer to execute:
setting a costume for two or more of a plurality of player characters, wherein the costume is selected by a player from among a plurality of costumes owned by the player;
matching up the player characters whose costumes have been set;
identifying, from among the matched up player characters, a player character whose set costume has a lower value than a predetermined value; and
giving a special reward to the player in response to a play evaluation of the player associated with the identified player character satisfying a game condition.

2. The non-transitory computer readable recording medium according to claim 1, wherein
the costume lacks a parameter advantageous to the game.

3. The non-transitory computer readable recording medium according to claim 2, wherein
the game is a cooperative game in which the player characters constituting a team cooperate with each other, and
the player characters constituting the team are matched up.

4. The non-transitory computer readable recording medium according to claim 3, wherein
the predetermined value is an average value of the set costumes of the remaining player characters constituting the team.

5. The non-transitory computer readable recording medium according to claim 1, wherein
the special reward is a special costume with a higher value than the set costumes of the identified player character.

6. The non-transitory computer readable recording medium according to claim 1, wherein
the special reward is a right to purchase a special costume with a higher value than the set costumes of the identified player character.

7. The non-transitory computer readable recording medium according to claim 6, wherein
the special reward is the right to purchase the special costume at a lower purchase price than usual.

8. The non-transitory computer readable recording medium according to claim 1, wherein
the special reward is given to the player in response to the player associated with the identified player character being a paying player during a specific period.

9. An information processing device that executes a multiplayer game, the information processing device comprising:
a central processing unit (CPU) that:
sets a costume for two or more of a plurality of player characters, wherein the costume is selected by a player from among a plurality of costumes owned by the player,
matches up the player characters whose costumes have been set,
identifies, from among the matched up player characters, a player character whose set costume has a lower value than a predetermined value, and
gives a special reward to the player in response to a play evaluation of the player associated with the identified player character satisfying a game condition.
